(19) United States
(12) Patent Application Publication
(10) Pub. No.: US 2013/0059552 A1
(43) Pub. Date: Mar. 7, 2013

(54) CITIZENS BAND RADIO EARPIECE

(71) Applicant: Ronald Tucker, Goulds, FL (US)

(72) Inventor: Ronald Tucker, Goulds, FL (US)

(21) Appl. No.: 13/224,742

(22) Filed: Sep. 2, 2011

(51) Int. Cl. H04W 88/02

(52) U.S. Cl. 455/90.2

(57) ABSTRACT

The present invention is a citizens band radio earpiece utilized by a user with an ear that includes an ear hook that wraps around the user's right ear or left ear, a microphone with a threaded proximal end that serves as a male portion that is removably screwed into and accommodated by a threaded female portion of the earpiece and a volume control button that controls the volume levels of the sounds received by the earpiece. The earpiece also includes an automatic cut-off switch, a three-tiered earpiece that generates sound from a CB radio signal received by and transmitted to the CB radio earpiece, a pair of charging cords that are utilized to initially charge and recharge the earpiece and a portable activation button that includes a depressible button portion.

### TECHNICAL FIELD & BACKGROUND

Individuals such as truck drivers, law enforcement personnel, fire fighters and the like, utilize citizen band radios to communicate pertinent information. Current citizen band radios on the market offer limited alternatives when it comes to any hands-free operation.

The present invention generally relates to an earpiece. More specifically, the invention is a hands-free citizen band radio earpiece.

It is an object of the invention to provide a hands-free citizens band radio earpiece that allows a user to utilize their hands while utilizing a citizens band radio.

It is an object of the invention to provide a user a hands-free method for communicating over a citizens band radio.

What is really needed is a hands-free citizens band radio earpiece that allows a user to utilize their hands while utilizing a citizens band radio that provides a hands-free method for communicating over a citizens band radio.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a side perspective view of a citizens band radio earpiece, in accordance with one embodiment of the present invention.

FIG. 1B illustrates a side perspective view of a flexible device that connects to a citizens band radio, in accordance with one embodiment of the present invention.

FIG. 1C illustrates an overhead perspective view of a portable activation button of a citizens band radio earpiece, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

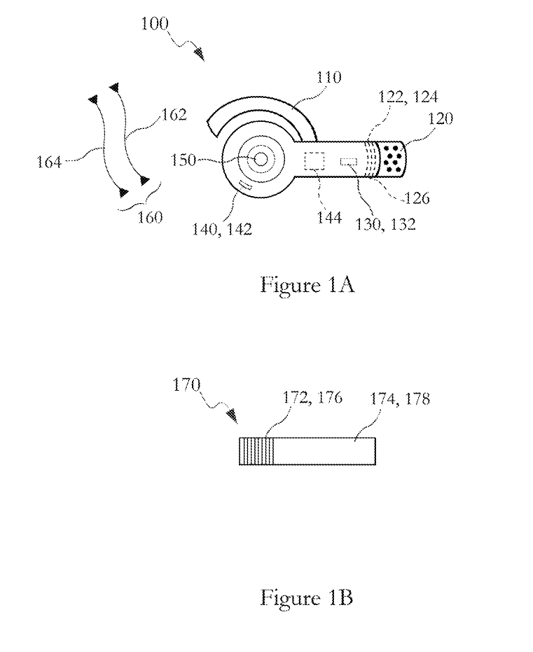

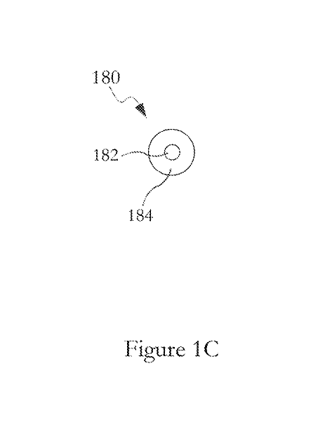

FIG. 1A illustrates a side perspective view of a citizens band radio earpiece 100, in accordance with one embodiment of the present invention.

The citizens band radio earpiece or CB radio earpiece 100 includes an ear hook 110, a microphone 120, a volume control button 130, an automatic cut-off switch 140, a three-tiered earpiece 150 and a pair of electrical cords 160.

The ear hook 110 wraps around a user's ear (not shown) and removably secures the CB radio earpiece 100 to the user's ear. The microphone 120 has a threaded proximal end 122 that serves as a male portion 124 that is removably screwed into and is accommodated by a threaded female portion 126 of the CB radio earpiece 100. The volume control button 130 can be a push button 132 that sequentially controls the volume levels, a slidable button or other suitable control button that controls a plurality of volume levels of the sound received by the CB radio earpiece 100. The automatic cut-off switch 140 is a push button switch 142, a toggle switch or other suitable switch that can be activated to turn-off power typically provided to the CB radio earpiece 100 by a battery 144 or other suitable portable power source. The automatic cut-off switch 140 terminates power to the CB radio earpiece 100 after a predetermined time period which can be a suitable predetermined time period. The battery 144 utilized with the CB radio earpiece 100 is typically a rechargeable battery that can also be any type of suitable battery. The three-tiered earpiece 150 generates sound from the CB radio signal received by and transmitted to the CB radio earpiece 100. The pair of electrical cords 160 are a pair of electrical charging cords that include a DC charging cord 162 and an AC charging cord 164 that can be utilized to initially charge and recharge the battery 144 of the CB radio earpiece 100.

FIG. 1B illustrates a side perspective view of a flexible device 170 that replaces the microphone and sends a signal to the CB radio earpiece 100 for communication in accordance with one embodiment of the present invention.

The flexible device depicts a threaded male portion 172 that can be screwed into and accommodated by the threaded female portion of a CB radio. The flexible portion 174 is connected on the end of the threaded male section 172 and can be a flexible antenna 178 or other suitable portion. The flexible portion allows the CB radio earpiece 100 to receive a signal from the CB radio.

FIG. 1C illustrates an overhead perspective view of a portable activation button 180 of a citizens band radio earpiece 100, in accordance with one embodiment of the present invention.

The portable activation button 180 includes a depressible button portion 182 and a base portion 184. The portable activation button 180 is battery-operated and is in communication with the CB radio earpiece 100 utilizing any suitable communications technology such as wireless technology or Bluetooth technology. The depressible button portion 182 turns-on and off the CB radio earpiece 100 from any suitable location by depressing the depressible button portion 182. The base portion 184 receives the depressible button portion 182 that is disposed on the base portion 184 that is placed on any suitable surface.

The CB radio earpiece has a similar shape, size and weight to that of a cell phone Bluetooth earpiece. While operating in conjunction with a citizen band radio, the CB radio earpiece is a relatively superior alternative to other CB communication devices. The CB radio earpiece is convenient and easy to use and is a three-tiered earpiece equipped with an ear hook, a built-in microphone and one or more volume control buttons, eliminating the need for a handheld microphone. The CB radio earpiece is versatile and is packaged with a screw-on flexible device that connects and allows the CB radio to receive a CB radio signal. The CB radio earpiece is battery operated and includes both AC and DC electrical cords for charging. The CB radio earpiece features an automatic cut-off switch built into the ear piece for preserving battery life. The CB radio earpiece is designed to also provide a safe environment that allows hands-free use while operating a motor vehicle.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A citizens band radio earpiece utilized by a user with an ear, comprising:
an ear hook that wraps around said user's ear and removably secures said earpiece to said user's ear;
a microphone with a threaded proximal end that serves as a male portion that is removably screwed into and accommodated by a threaded female portion of said earpiece;
a volume control button that controls a plurality of volume levels of a plurality of sounds received by said earpiece;
an automatic cut-off switch to turn-off power provided to said earpiece;
a three-tiered earpiece that generates sound from a CB radio signal received by and transmitted to said CB radio earpiece;
a pair of electrical cords that include a pair of charging cords that are utilized to initially charge and recharge said earpiece; and
a portable activation button that includes a depressible button portion and a base portion.

2. The earpiece according to claim 1, wherein said volume control button controls any switches that sequentially controls said volume levels.

3. The earpiece according to claim 1, wherein said automatic cut-off switch terminates power to said earpiece after a predetermined time period.

4. The earpiece according to claim 1, wherein said power provided to said earpiece is from a battery.

5. The earpiece according to claim 1, wherein said pair of charging cords include a DC charging cord to initially charge and recharge said earpiece.

6. The earpiece according to claim 1, wherein said pair of charging cords include an AC charging cord to initially charge and recharge said earpiece.

7. A citizens band radio earpiece utilized by a user with a right ear and a left ear, comprising:
an ear hook that wraps around said user's right ear or said left ear and removably secures said earpiece to said user's ear;
a microphone with a threaded proximal end that serves as a male portion that is removably screwed into and accommodated by a threaded female portion of said earpiece;
a volume control button that controls a plurality of volume levels of a plurality of sounds received by said earpiece;
an automatic cut-off switch to turn-off power provided to said earpiece;
a three-tiered earpiece that generates sound from a CB radio signal received by and transmitted to said CB radio earpiece;
a pair of charging cords that are utilized to initially charge and recharge said earpiece; and
a portable activation button that includes a depressible button portion and a base portion.

8. The earpiece according to claim 7, wherein said volume control button controls any switches that sequentially controls said volume levels.

9. The earpiece according to claim 7, wherein said automatic cut-off switch terminates power to said earpiece after a predetermined time period.

10. The earpiece according to claim 7, wherein said power provided to said earpiece is from a battery.

11. The earpiece according to claim 10, wherein said battery is a rechargeable battery.

12. The earpiece according to claim 7, wherein said pair of charging cords include a DC charging cord to initially charge and recharge said earpiece.

13. The earpiece according to claim 7, wherein said pair of charging cords include an AC charging cord to initially charge and recharge said earpiece.

14. A citizens band radio earpiece utilized by a user with a right ear and a left ear, comprising:
an ear hook that wraps around said user's right ear or said user's left ear and removably secures said earpiece to said user's ear;
a volume control button that controls a plurality of volume levels of a plurality of sounds received by said earpiece;
an automatic cut-off switch to turn-off power provided to said earpiece;
a three-tiered earpiece that generates sound from a CB radio signal received by and transmitted to said CB radio earpiece;
a pair of charging cords that are utilized to initially charge and recharge said earpiece;
a portable activation button that includes a depressible button portion and a base portion; and
a threaded device that includes a proximal end and a flexible portion, wherein said proximal end has a threaded male portion disposed on said proximal end that is removably screwed into and accommodated by a threaded female portion of said CB radio.

15. The earpiece according to claim 14, wherein said volume control button controls any switches that sequentially controls said volume levels.

16. The earpiece according to claim 14, wherein said automatic cut-off switch terminates power to said earpiece after a predetermined time period.

17. The earpiece according to claim 14, wherein said power provided to said earpiece is from a battery.

18. The earpiece according to claim 17, wherein said battery is a rechargeable battery.

19. The earpiece according to claim 14, wherein said pair of charging cords include a DC charging cord and an AC charging cord to initially charge and recharge said earpiece.

20. The earpiece according to claim 14, wherein said flexible portion is a flexible antenna.
